(19) United States
(12) Patent Application Publication
(10) Pub. No.: US 2024/0167830 A1
(43) Pub. Date: May 23, 2024

(54) ENERGY PREDICTION APPARATUS

(71) Applicant: DENSO CORPORATION, Kariya-city (JP)

(72) Inventor: Hiroyuki NANJO, Kariya-city (JP)

(73) Assignee: DENSO CORPORATION, Kariya-city (JP)

(21) Appl. No.: 18/507,426

(22) Filed: Nov. 13, 2023

(30) Foreign Application Priority Data
Nov. 11, 2022 (JP) 2022-181350

(51) Int. Cl. G01C 21/34; G01C 21/00; G01C 21/36

(52) U.S. Cl. CPC G01C 21/3469; G01C 21/3691; G01C 21/3885

(57) ABSTRACT

In an energy prediction apparatus, a first generator predicts a vehicle-speed fluctuation condition indicative of how a speed of a target vehicle fluctuates over time while the target vehicle will travel along a scheduled travel route to accordingly generate the vehicle-speed fluctuation condition as first predicted information. A second generator predicts, based on the first predicted information, required travel energy required for the target vehicle to travel along the scheduled travel route to accordingly generate the required travel energy as second predicted information. A third generator reflects retrieved environmental variation-factor information on the second predicted information, and predicts, based on the second predicted information on which the environmental variation-factor information has been reflected, total necessary energy required for the target vehicle to travel along the scheduled travel route to accordingly generate the total necessary energy as third predicted information.

### CROSS-REFERENCE TO RELATED APPLICATION

This application is based on and claims the benefit of priority from earlier Japanese Patent Application No. 2022-181350 filed on Nov. 11, 2022, the entire disclosure of which is incorporated herein by reference.

### TECHNICAL FIELD

The present disclosure relates to energy prediction apparatuses.

### BACKGROUND

Japanese Patent Application Publication No. 2012-255757 discloses a method of estimating energy consumption in a vehicle. Specifically, the method disclosed in the patent publication estimates the amount of energy consumption in a vehicle for each predetermined section while the vehicle is traveling in the corresponding predetermined section. The method disclosed in the patent publication determines the actual amount of energy supplied from an energy supplier to the vehicle for each predetermined section while the vehicle is traveling in the corresponding predetermined section.

Then, the method disclosed in the patent publication corrects, based on a difference between the estimated amount of energy consumption and the determined actual amount of energy for each predetermined section, the estimated amount of energy consumption for the corresponding predetermined section.

### SUMMARY

The method disclosed in the patent publication estimates the amount of energy consumption in a vehicle for each predetermined section while the vehicle is traveling in the corresponding predetermined section, and corrects the estimated amount of energy consumption for each predetermined section.

Various factors of energy consumption in a vehicle for each predetermined section, which may vary as compared to those for another section, may result in reduction in the correction accuracy of the estimated amount of energy consumption for each predetermined section.

In order to increase the correction accuracy of the estimated amount of energy consumption for each predetermined section, there is an additional approach that estimates the amount of energy consumption in a vehicle for each energy-consumption factor and for each predetermined section while the vehicle is traveling in the corresponding predetermined section, and corrects the estimated amount of energy consumption for each energy-consumption factor and for each predetermined section.

This additional approach may however cause correction of the estimated amount of energy consumption for each energy-consumption factor and for each predetermined section to become complicated. This may reduce the installability of software based on the additional approach.

Additionally, the above conventional approaches disclose no prediction of total necessary energy that will have been totally required by a target vehicle when the target vehicle will travel along a scheduled travel route.

In view of the circumstances set forth above, an exemplary aspect of the present disclosure seeks to provide energy prediction apparatuses, each of which offers how to predict total necessary energy that will have been totally required by a target vehicle when the target vehicle will travel along a scheduled travel route with facility and high accuracy.

A first exemplary aspect according to the present disclosure provides an energy prediction apparatus that includes a first generator configured to predict a vehicle-speed fluctuation condition indicative of how a speed of a target vehicle fluctuates over time while the target vehicle will travel along a scheduled travel route to accordingly generate the vehicle-speed fluctuation condition as first predicted information. The energy prediction apparatus includes a second generator configured to predict, based on the first predicted information, required travel energy required for the target vehicle to travel along the scheduled travel route to accordingly generate the required travel energy as second predicted information. The energy prediction apparatus includes an information retrieving unit configured to retrieve environmental variation-factor information on the scheduled travel route. The environmental variation-factor information has an influence on energy consumed by the target vehicle during traveling of the target vehicle along the scheduled travel route. The energy prediction apparatus includes a third generator configured to reflect the environmental variation-factor information on the second predicted information, and predict, based on the second predicted information on which the environmental variation-factor information has been reflected, total necessary energy required for the target vehicle to travel along the scheduled travel route to accordingly generate the total necessary energy as third predicted information.

A second exemplary aspect provides a processor-readable storage medium including a set of program instructions that cause at least one processor to
(I) Predict a vehicle-speed fluctuation condition indicative of how a speed of a target vehicle fluctuates over time while the target vehicle will travel along a scheduled travel route to accordingly generate the vehicle-speed fluctuation condition as first predicted information
(II) Predict, based on the first predicted information, required travel energy required for the target vehicle to travel along the scheduled travel route to accordingly generate the required travel energy as second predicted information
(III) Retrieve environmental variation-factor information on the scheduled travel route, the environmental variation-factor information having an influence on energy consumed by the target vehicle during traveling of the target vehicle along the scheduled travel route
(IV) Reflect the environmental variation-factor information on the second predicted information
(V) Predict, based on the second predicted information on which the environmental variation-factor information has been reflected, total necessary energy required for the target vehicle to travel along the scheduled travel route to accordingly generate the total necessary energy as third predicted information

A third exemplary aspect provides a method, executable by a processor, including
(I) Predicting a vehicle-speed fluctuation condition indicative of how a speed of a target vehicle fluctuates over time while the target vehicle will travel along a scheduled travel route to accordingly generate the vehicle-speed fluctuation condition as first predicted information
(II) Predicting, based on the first predicted information, required travel energy required for the target vehicle to travel along the scheduled travel route to accordingly generate the required travel energy as second predicted information
(III) Retrieving environmental variation-factor information on the scheduled travel route, the environmental variation-factor information having an influence on energy consumed by the target vehicle during traveling of the target vehicle along the scheduled travel route
(IV) Reflecting the environmental variation-factor information on the second predicted information
(V) Predicting, based on the second predicted information on which the environmental variation-factor information has been reflected, total necessary energy required for the target vehicle to travel along the scheduled travel route to accordingly generate the total necessary energy as third predicted information

Each of the first to third aspects according to the present disclosure offers information about how to predict the total necessary energy that will have been totally required by the target vehicle with facility and/or high accuracy.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating an energy prediction apparatus according to the first embodiment of the present disclosure;

FIG. 2 is a flowchart schematically illustrating an energy prediction routine according to the first embodiment;

FIG. 3 is a graph schematically illustrating an example of a vehicle-speed fluctuation pattern;

FIG. 4 is a block diagram schematically illustrating an example of a vehicle drive system employed by a target vehicle that is an electric vehicle;

FIG. 5 is a graph schematically illustrating a relationship between an efficiency of an electrical drive system illustrated in FIG. 4 and input energy from the electrical drive system to a mechanical power transmission system illustrated in FIG. 4;

FIG. 6 is a block diagram schematically illustrating an example of a vehicle drive system employed by the target vehicle that is an engine vehicle;

FIG. 7 is a graph schematically illustrating a relationship between an efficiency of an engine illustrated in FIG. 6 and input energy supplied from the engine to a mechanical power transmission system illustrated in FIG. 6;

FIG. 8 is a graph schematically illustrating an example of a past actual vehicle-speed fluctuation pattern;

FIG. 9 is a graph schematically illustrating an example of a correction coefficient as a function of the amount of snow on a specified travel route;

FIG. 10 is a graph schematically illustrating map information indicative of a relationship between the amount of snow along the specified travel route and required travel energy required for the traveling of the target vehicle along the specified travel route;

FIG. 11 is an example of the past actual vehicle-speed fluctuation pattern and an example of the vehicle-speed fluctuation pattern;

FIG. 12 is a flowchart schematically illustrating an energy prediction routine according to the second embodiment;

FIG. 13 is a graph schematically illustrating how to calculate consumed travel-unrelated energy;

FIG. 14 is a flowchart schematically illustrating an energy prediction routine according to the third embodiment;

FIG. 15 is a graph schematically illustrating an example of a correction coefficient as a function of an outside temperature;

FIG. 16 is a graph schematically illustrating map information indicative of a relationship between the outside temperature around the specified travel route and travel-unrelated energy;

FIG. 17 is a flowchart schematically illustrating an energy prediction routine according to the fourth embodiment;

FIG. 18 is a graph schematically illustrating an example of map information indicative of a relationship between values of the probability of the amount of snow on the respective sampled points of the specified travel route and corresponding values of the correction coefficient.

FIG. 19 is a graph schematically illustrating an example of map information indicative of a relationship between values of the probability of the outside temperature around the respective sampled points of the specified travel route and corresponding values of the correction coefficient;

FIG. 20 is a graph schematically illustrating an example of map information indicative of a relationship between values of the probability of the amount of snow on the respective sampled points of the specified travel route and corresponding values of corrected required travel energy; and

FIG. 21 is a graph schematically illustrating an example of map information indicative of a relationship between values of the probability of the outside temperature around the respective sampled points of the specified travel route and corresponding values of travel-unrelated energy.

### DETAILED DESCRIPTION OF EMBODIMENT

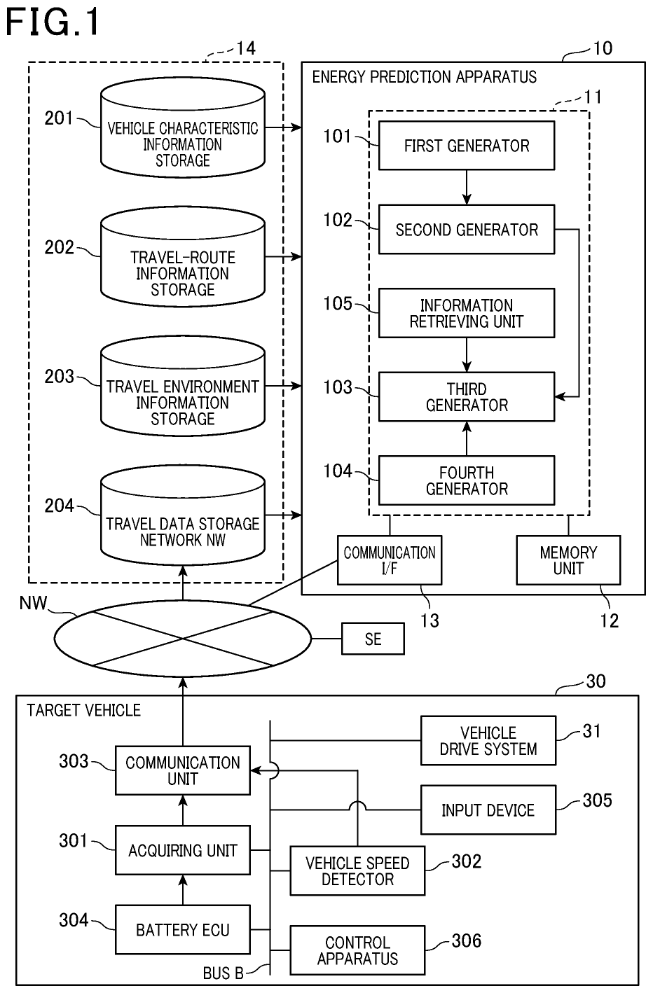

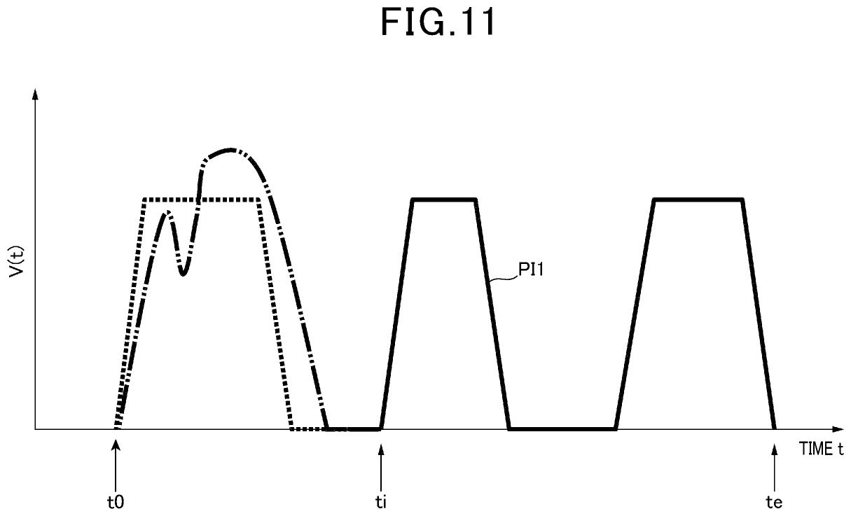

The following describes exemplary embodiments of the present disclosure with reference to FIGS. 1 to 21. In the exemplary embodiments, descriptions of like parts, to which like reference characters are assigned as much as possible, are omitted or simplified to avoid redundant description.

### First Embodiment

The following describes an energy prediction apparatus 10 according to the first embodiment with reference to FIG. 1.

The energy prediction apparatus 10 is used for a target vehicle 30; the target vehicle 30 is designed as an electric vehicle, an engine vehicle, or a hybrid vehicle. The vehicle 30 includes a vehicle drive system 31 installed therein, which will be described later.

The energy prediction apparatus 10 is comprised of at least one computer system essentially including a processor 11, such as a central processor (CPU) 11, a memory unit 12 including at least one of a random-access memory (RAM), a read-only memory (ROM) and other memory devices, and a communication interface (I/F) 13. The communication interface 13 enables the processor 11 and other devices located outside the energy prediction apparatus 10 to communicate with each other.

The memory unit 12 stores one or more programs, i.e., program instructions of one or more programs.

The processor, referred to simply as the CPU, 11 functionally includes, for example, a first generator 101, a second generator 102, a third generator 103, a fourth generator 104, and an information retrieving unit 105.

The CPU 11 is configured to run the one or more programs, i.e., instructions of the one or more programs, stored in the memory unit 12, thus implementing various functions corresponding to the one or more programs; the various functions include, for example, the above functions 101 to 105.

The CPU 11 is configured to communicate, through the communication interface 13, with a storage apparatus 14 located separately from the energy prediction apparatus 10. The energy prediction apparatus 10 can be comprised of the storage apparatus 14.

At least part of all functions, which include the functions 101 to 105, provided by the energy prediction apparatus 10 can be implemented by at least one processor, such as the CPU 11; the at least one processor can be comprised of
(1) The combination of at least one programmable processing unit, i.e., at least one programmable logic circuit, and at least one memory
(2) At least one hardwired logic circuit
(3) At least one hardwired-logic and programmable-logic hybrid circuit

The storage apparatus 14 includes a vehicle characteristic information storage 201, a travel-route information storage 202, a travel environment information storage 203, and a travel data storage 204.

The vehicle characteristic information storage 201 stores values of predetermined vehicle characteristic parameters for the target vehicle 30. The predetermined vehicle characteristic parameters include, for example, (i) a gross vehicle mass W, (ii) an air-resistance coefficient Cd, (iii) a frontal projected area A, and (iv) a rolling-resistance coefficient μ of the target vehicle 30.

The travel-route information storage 202 stores information, which will also be referred to as travel-route information, about a previously specified travel route of the target vehicle 30 from a predetermined start location to a predetermined destination.

Let us assume that the target vehicle 30 is going to travel along the specified travel route from a predetermined start time t0; the specified travel route has been stored in, for example, the memory unit 12. A speed of the target vehicle 30 can be therefore expressed as a function of time t that has elapsed since the start time to, so that the speed of the target vehicle 30 can be expressed as V(t).

The travel-route information about the specified travel route includes, for example, latitude information items, longitude information items, and altitude information items.

The latitude information item on each sampled point of the specified travel route shows the latitude of the corresponding sampled point, the longitude information item on each sampled point of the specified travel route shows the longitude of the corresponding sampled point, and the altitude information item on each sampled point of the specified travel route shows the altitude of the corresponding sampled point.

Various external servers ES, which are communicable with the storage apparatus 14 and the energy prediction apparatus 10 through a communication network NW, include, for example, a traffic information server that periodically collects various traffic information items on at least the specified travel route. The various traffic information items on each road for example include
(I) Traffic jam information about the level of traffic jams on the specified travel route
(II) Construction information about whether there is at least one construction area on the specified travel route
(III) Accident information about whether there has been one or more accidents on the specified travel route
(IV) Information about travel conditions for the specified travel route

The travel conditions for the specified travel route have an influence on the vehicle's traveling speed. The travel conditions for the specified travel route include, for example, the number of intersections on the specified travel route, and the number of traffic light devices on the specified travel route. The traffic information on the specified travel route includes the legal speed of the corresponding section of the specified travel route corresponding route.

The travel environment information storage 203 stores the traffic information items on the specified travel route each time the traffic information items on the specified travel route are sent from the traffic information server.

The travel environment information storage 203 additionally stores environmental variation-factor information about the specified travel route; the environmental variation-factor information has an influence on energy consumption of the target vehicle 30 during traveling of the target vehicle 30 along specified travel route. The environmental variation-factor information includes, for example, a first variation factor that has an influence on energy consumed by the traveling itself of the target vehicle along the specified travel route. The environmental variation-factor information also includes, for example, a second variation factor that has an influence on independent energy consumed, when the target vehicle travels along the specified travel route, in the target vehicle 30 independently from the traveling of the target vehicle 30 along the specified travel route.

The first variation factor includes, for example, the amount of snow on each sampled point of the specified travel route and/or a correction coefficient based on the amount of snow on each sampled point of the specified travel route. The second variation factor includes, for example, the outside temperature around each sampled point of the specified travel route and/or a correction coefficient based on the outside temperature around each sampled point of the specified travel route.

The travel data storage 204 stores traveling data of the target vehicle 30 sent from the target vehicle 30 while the target vehicle 30 is traveling at each sampled point of the specified travel route.

The traveling data of the target vehicle 30 may include, for example, (i) the state of charge (SOC) of a battery B included in the vehicle drive system 31 of the target vehicle 30 at each sampled point of the specified travel route, (ii) the speed of the target vehicle 30 at each sampled point of the specified travel route, and (iii) the longitude and latitude of the target vehicle 30 at each sampled point of the specified travel route.

The first generator 101 predicts, at time t=ti, first predicted information on a future vehicle-speed fluctuation pattern, i.e., a pattern showing how the vehicle speed will fluctuate over time, while the target vehicle 30 will travel along a scheduled travel route included in the specified travel route.

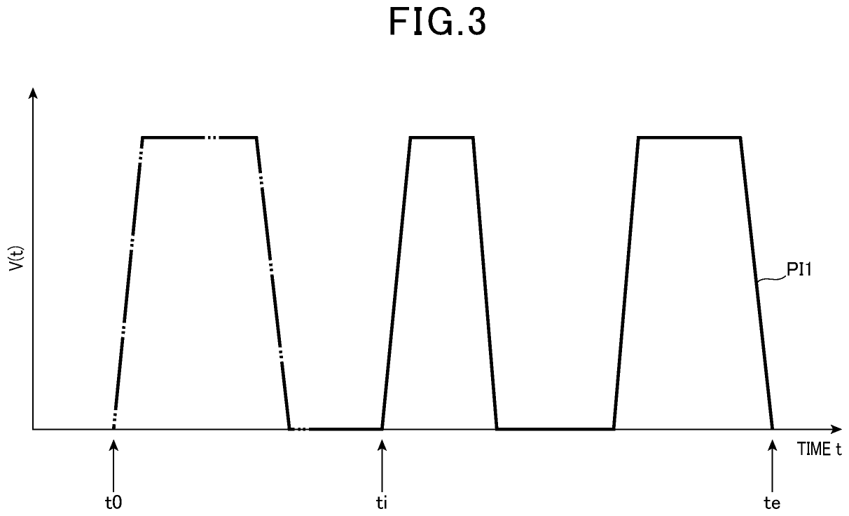

FIG. 3 illustrates, as a graph, an example of the first predicted information (see reference character PI1) representing the future vehicle-speed fluctuation pattern of the target vehicle 30 from the time, i.e., prediction-request time, t=ti to the time, i.e., end time, t=te while the target vehicle 30, which has started from the start location at the start time to, will travel along the scheduled travel route included in the specified travel route. The horizontal axis of the graph shows time t that has elapsed since the start time t0, and the vertical axis of the graph shows the speed, which is expressed by V(t), of the target vehicle 30 at time t.

Specifically, the first generator 101 predicts the first predicted information PI1 on the future vehicle-speed fluctuation pattern of the target vehicle 30 in accordance with, for example, (i) the traveling data that has been sequentially obtained from the start time t=t0 to time t and stored in the travel data storage 204, (ii) the specified travel route, and (iii) the traffic information items on the specified travel route stored in the travel environment information storage 203.

The second generator 102 predicts required travel energy based on (i) the first predicted information PI1, (ii) the travel-route information stored in the travel-route information storage 202, and (iii) the values of the predetermined vehicle characteristic parameters stored in the vehicle characteristic information storage 201. The required travel energy represents energy required for the target vehicle 30 to travel along the scheduled travel route in accordance with the first predicted information PI1 on the future vehicle-speed fluctuation pattern. The second generator 102 accordingly generates the predicted required travel energy as second predicted information PI2.

How the second generator 102 generates the second predicted information PI2 will be described in detail later.

The information retrieving unit 105 retrieves the environmental variation-factor information stored in the travel environment information storage 203.

The third generator 103 can perform a first task of generating, as third predicted information PI3, total necessary energy required for the target vehicle 30 to travel along the scheduled travel route.

The fourth generator 104 predicts, as fourth predicted information PI4, travel-unrelated energy required, when the target vehicle 30 travels along the scheduled travel route, by the target vehicle 30 independently from the traveling of the target vehicle 30 along the scheduled travel route.

How the fourth generator 104 generates the fourth predicted information PI4 will be described in detail later.

The third generator 103 can perform a second task of reflecting the first variation factor included in the retrieved environmental variation-factor information on the second predicted information PI2 to accordingly predict, as third predicted information PI3, the total necessary energy required for the target vehicle 30 to travel along the scheduled travel route in accordance with (i) the second predicted information PI2 on which the first variation factor has been reflected and (ii) the fourth predicted information PI4.

For example, the third generator 103 corrects the second predicted information PI2 in accordance with a correction coefficient that represents the probability of occurrence of the first variation factor to accordingly reflect the first variation factor included in the retrieved environmental variation-factor information on the second predicted information PI2.

The target vehicle 30, which is a prediction target by the energy prediction apparatus 10, is communicable with the storage apparatus 14 and the energy prediction apparatus 10 through the communication network NW. While the target vehicle 30 is traveling along the specified travel route, the target vehicle 30 is configured to send, to the traveling data storage 204, the traveling data at each sampled point of the specified travel route, so that the traveling data of the target vehicle 30 at each sampled point of the specified travel route is stored in the travel data storage 204.

Specifically, the target vehicle 30 includes, in addition to the vehicle drive system 31, an acquiring unit 301, a vehicle speed detector 302, a communication unit 303, a battery electronic control unit (ECU) 304, an input device 305, and a control apparatus 306.

The control apparatus 306 is communicable with the other components 301 to 305 through a bus B.

The battery ECU 304 is configured to monitor and control the SOC of the battery B included in the vehicle drive system 31.

The acquiring unit 301 is configured to acquire, from the battery ECU 304, a value of the SOC of the battery B at each sampled point of the specified travel route.

The acquiring unit 301 is also configured to acquire positional information on the target vehicle 30, which includes the longitude and latitude of the target vehicle 30, at each sampled point of the specified travel route.

The vehicle speed detector 302 is configured to detect the speed of the target vehicle VE at each sampled point of the specified travel route.

The communication unit 303 is configured to send, to the travel data storage 204, the set of (i) the SOC of the battery B, (ii) the positional information on the target vehicle 30, and (iii) the speed of the target vehicle VE at each sampled point of the specified travel route as the traveling data at the corresponding sampled point of the specified travel route.

The input device 305 is configured to enable a driver of the target vehicle 30 to enter various input information items to the control apparatus 305.

The control apparatus 306 is configured to obtain, from the acquiring unit 301, (i) the value of the SOC of the battery B and (ii) the positional information on the target vehicle 30 at each sampled point of the specified travel route, and obtain, from the vehicle speed detector 302, the speed of the target vehicle VE at each sampled point of the specified travel route.

The control apparatus 306 is additionally control, while communicating with the battery ECU 304, the vehicle drive system 31 based on the obtained value of the SOC of the battery B, the obtained positional information on the target vehicle 30, and the obtained speed of the target vehicle 30 at each sampled point of the specified travel route to accordingly cause the target vehicle 30 to travel.

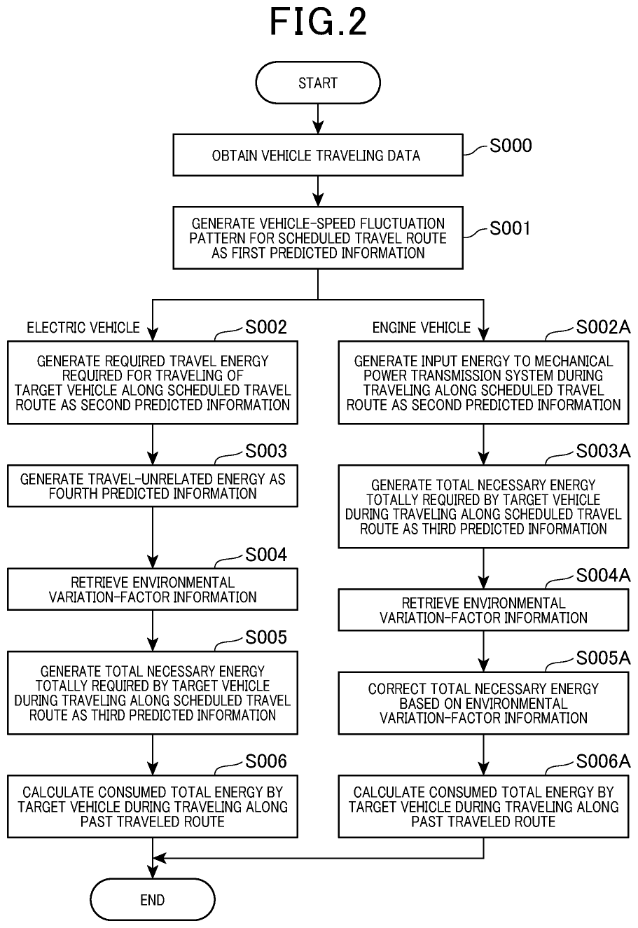

Next, the following describes an energy prediction routine based on the program instructions of the one or more programs stored in the memory unit 12 according to the first embodiment using the flowchart of FIG. 2; the energy prediction routine is carried out by the CPU 11 of the energy prediction apparatus 10.

Let us assume that the target vehicle 30 is, which has departed from the start location at the start time to, traveling along the specified travel route.

In step S000 of the energy prediction routine, the CPU 11 of the of the energy prediction apparatus 10 obtains, at each sampled point of the specified travel route in real time, the traveling data of the target vehicle 30 to store it in the travel data storage 204. The traveling data at each sampled point of the specified travel route may include, for example, (i) the state of charge (SOC) of the battery B included in the vehicle drive system 31 of the target vehicle 30 at the corresponding sampled point of the specified travel route, (ii) the speed of the target vehicle 30 at the corresponding sampled point of the specified travel route, and (iii) the longitude and latitude of the target vehicle 30 at the corresponding sampled point of the specified travel route.

For example, at time t=ti, a driver of the target vehicle 30 operates the input device 305 to input an energy prediction request, so that the energy prediction request is sent from the target vehicle 30 to the energy prediction apparatus 10.

In response to the energy prediction request sent from the target vehicle 30, at the time ti, i.e., the prediction-request time ti, the CPU 11 serves as the first generator 101 to predict the first predicted information PI1 in accordance with, for example, (i) the traveling data that has been sequentially obtained from the start time t0 to the prediction-request time ti and stored in the travel data storage 204, (ii) the specified travel route, and (iii) the traffic information items on the specified travel route stored in the travel environment information storage 203 in step S001 (see FIG. 3).

The first predicted information PI1 represents the future vehicle-speed fluctuation pattern V(t), i.e., the pattern showing how the vehicle speed will fluctuate over time t from the prediction-request time ti to the end time te, while the target vehicle 30 will travel along the scheduled travel route included in the specified travel route.

Note that, in addition to the first predicted information (future vehicle-speed fluctuation pattern) PI1, FIG. 3 shows a predicted past vehicle-speed fluctuation pattern PI0 that can be calculated based on the specified travel route and the traffic information items on the specified travel route stored in the travel environment information storage 203.

Next, the CPU 11 serves as the second generator 102 to predict, as the second predicted information P12, required travel energy that will have been required for the traveling of the target vehicle 30 in accordance with the future vehicle-speed fluctuation pattern V(t) from the prediction-request time ti to the end time te generated in step S001, (ii) the travel-route information stored in the travel-route information storage 202, and (iii) the values of the predetermined vehicle characteristic parameters stored in the vehicle characteristic information storage 201 in step S002.

Specifically, the CPU 11, which serves as the second generator 102, can predict the required travel energy in accordance with traveling horsepower, and the CPU 11, which serves as the second generator 102, can calculate the traveling horsepower in accordance with a running resistance, i.e., a traveling load.

The running resistance, which is comprised of an acceleration resistance, a reference air resistance, a hill climbing resistance, and a rolling resistance, can be expressed as a function of (i) the gross vehicle mass W, (ii) the air-resistance coefficient Cd, (iii) the frontal projected area A, and (iv) the rolling-resistance coefficient μ of the target vehicle 30, which are stored in the vehicle characteristic information storage 201.

Specifically, the CPU 11 calculates the running resistance, which will be referred to as F_{drv}, in accordance with the following formula [f01]:

F_{drv}=Wa(t)+0.5*p*Cd*AV²(t)+μWg+g sin θ(t) [f01]
where:
F_{drv} represents the running resistance;
W represents the gross vehicle mass;
a(t) represents the acceleration at time t;
p represents air density;
Cd represents the air-resistance coefficient;
A represents the frontal projected area;
V(t) represents the predicted future vehicle-speed fluctuation pattern;
μ represents the rolling-resistance coefficient;
g represents the acceleration of gravity;
θ(t) represents a predetermined gradient angle of the scheduled travel route with respect to a reference horizontal plane;
Wa(t) represents the acceleration resistance;
0.5*ρ*Cd*AV²(t) represents the reference air resistance (aerodynamic drag);
μWg represents the hill climbing resistance; and
g sin θ(t) represents the rolling resistance.

The air density ρ can be set to a fixed value of, for example, 1.293 kg/m³, or can be calculated in accordance with a specified air temperature, which can be measured by a temperature sensor installed in the selected vehicle model or inputted by a user through the I/O unit 15. The acceleration of gravity can be set to a fixed value of, for example, 9.8 m/s².

The gradient angle θ(t) can be set to a specified value inputted by a user through the I/O unit 15 or a fixed value, or can be calculated based on the latitude, longitude, and altitude of the target vehicle 30 at time t.

The CPU 11 can retrieve, from the vehicle characteristic information storage 201, the values of the predetermined vehicle characteristic parameters W, Cd, A, and μ. For example, the first embodiment uses the following values:
W=2,000 kg
Cd=0.3
A=5 m²
μ=0.1

In step S002, following the calculation of the running resistance F_{drv}, the CPU 11 calculates, based on the running resistance F_{drv}, the traveling horsepower, which will be referred to as P_{drv}(t) in accordance with the following formula [f02]:

P_{drv}(t)=F_{drv}*V(t) [f02]

In step S002, following the calculation of the traveling horsepower P_{drv}(t), the CPU 11 calculates, based on the traveling horsepower P_{drv}(t), input energy PI_{drv}(t) inputted to the vehicle drive system 31 in a case where the target vehicle 30 is an electric vehicle.

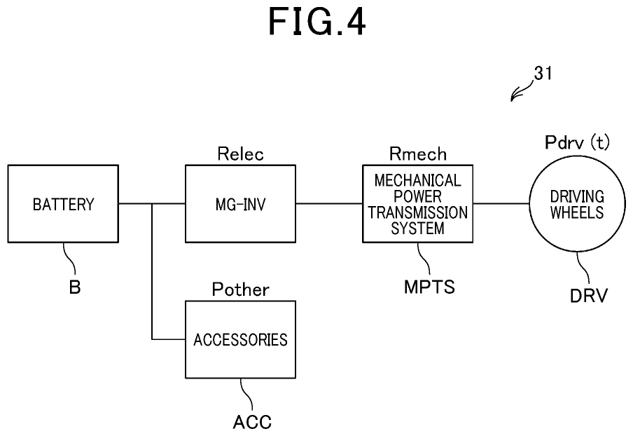

FIG. 4 is a block diagram schematically illustrating an example of the vehicle drive system 31 employed by the target vehicle (electric vehicle) 30.

Specifically, the vehicle drive system 31 includes the battery B, an electrical drive system MG-INV, which includes an inverter INV and a motor-generator MG, a mechanical power transmission system MPTS, driving wheels DRV, and accessories (ACC) including an air-conditioner. Specifically, the electrical drive system MG-INV creates drive power based on direct-current (DC) power supplied from the battery B to accordingly transmit the drive power, i.e., torque, to the driving wheels DRV through the mechanical power transmission system MPTS, making it possible to rotate the driving wheels DRV. The accessories ACC including the air-conditioner operate based on the DC power supplied from the battery B.

The electrical drive system MG-INV has a predetermined efficiency R_{elec}, and the mechanical power transmission system MPTS has a predetermined efficiency R_{mech} The efficiency R_{mech} of the mechanical power transmission system MPTS is set to a fixed value of, for example, 70%.

Specifically, the efficiency R_{mech} of the mechanical power transmission system MPTS shows that input energy inputted to the mechanical power transmission system MPTS is transferred to the driving wheels DRV with the efficiency R_{mech} (%), so that the traveling horsepower P_{drv}(t) is generated.

Accordingly, the CPU 11 calculates, based on the traveling horsepower P_{drv}(t), the input energy PI_{drv}(t) inputted to the mechanical power transmission system MPTS of the vehicle drive system 31 in accordance with the following formula [f03]:

PI_{drv}(t)=P_{drv}(t)/R_{mech} [f03]

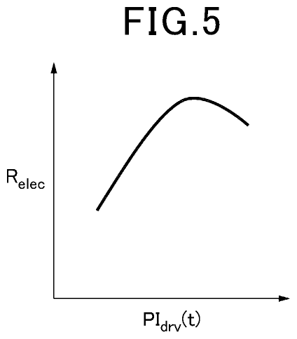

The efficiency R_{elec} of the electrical drive system MG-INV has a predetermined relationship with respect to the input energy PI_{drv}(t) supplied from the electrical drive system MG-INV to the mechanical power transmission system MPTS as illustrated in, for example, FIG. 5.

That is, the efficiency R_{elec} of the electrical drive system MG-INV is defined as a function ƒ of the input energy PI_{drv}(t) from the electrical drive system MG-INV to the mechanical power transmission system MPTS, and therefore the efficiency R_{elec} of the electrical drive system MG-INV can be expressed by the following formula [f04]:

R_{elec}=ƒ(PI_{drv}(t)) [f04]

Following the calculation of the input energy PI_{drv}(t), the CPU 11 calculates power, i.e., the rate of work, for traveling of the target vehicle 30, which will be referred to as PD_{drv}(t), in accordance with the following formula [f05]:

PD_{drv}(t)=PI_{drv}(t)/R_{elec} [f05]

Next, in step S002, the CPU 11 integrates the power PD_{drv}, from the prediction-request time ti to the end time te in accordance with the following formula [f06] to accordingly calculate the required travel energy that will have been required for the traveling of the target vehicle 30 in accordance with the future vehicle-speed fluctuation pattern V(t) from the prediction-request time ti to the end time te, which will be referred to as E^{ti}_{drv_prd_base}(te):

E^{ti}_{drv_prd_base}(te)=Σ(P_{drv}(t)*(t−(t−1))) [f06]

If the power PD_{drv}(t) has a negative value, the power PD_{drv}(t) serves as regenerative energy that is charged in the battery B.

Let us assume that energy required to drive the accessories ACC including the air-conditioner is defined as accessory-drive energy Pₒₜₕₑᵣ(t). The accessory-drive energy Pₒₜₕₑᵣ(t) required to drive the accessories ACC can be set to a fixed value of, for example, 5 kW.

Specifically, following the operation in step S002, the CPU 11 serves as, for example, the fourth generator 104 to integrate the accessory-drive energy Pₒₜₕₑᵣ(t) from the prediction-request time ti to the end time te in accordance with the following formula [f07] to accordingly calculate, as the fourth information, travel-unrelated energy required, when the target vehicle 30 will travel along the scheduled travel route from the prediction-request time ti to the end time to independently from the traveling of the target vehicle 30 along the sched, which will be referred to as E^{ti}_{other_prd_base}(te), in step S003:

E^{ti}_{other_prd_base}(te)=Σ(Pₒₜₕₑᵣ(t)*(t−(t−1))) [f07]

Following the operation in step S003, the CPU 11 serves as, for example, the information retrieving unit 105 to retrieve, from the travel environment information storage 203, the environmental variation-factor information stored in the travel environment information storage 203 in step S004.

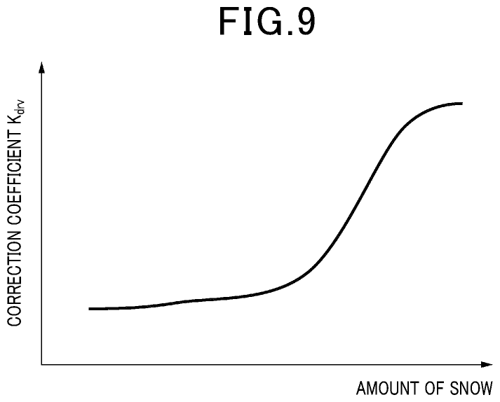

For example, the CPU 11 of the first embodiment retrieves, from the travel environment information storage 203, the correction coefficient, which will be referred to as K_{drv} based on the amount of snow on each sampled point of the specified travel route as the first variation factor in step S004. FIG. 9 shows an example of the correction coefficient K_{drv} as a function of the amount of snow on the specified travel route.

Next, the CPU 11 serves as, for example, the third generator 103 to correct the required travel energy E^{ti}__{prd_base}(te) by the correction coefficient K_{drv} to accordingly calculate corrected required travel energy E^{ti}_{drv_prd_cor}(te) in accordance with the following formula [f07A]:

E^{ti}_{drv_prd_cor}(te)=K_{drv}*E^{ti}__{prd_base}(te) [f07A]

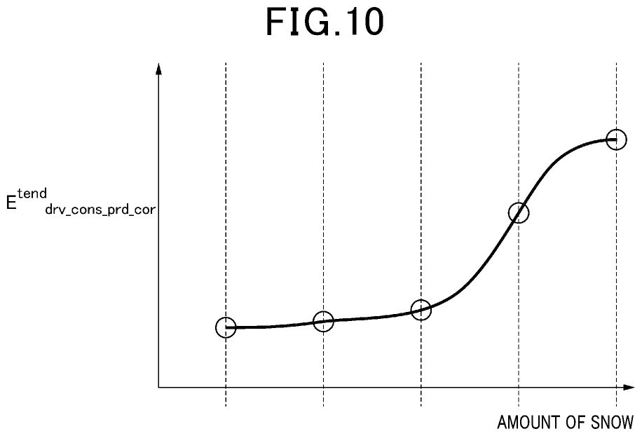

The energy prediction apparatus 10 or the travel environment information storage 203 can store map information indicative of a relationship between the first variation factor, i.e., the amount of snow along the specified travel route and required travel energy required for the traveling of the target vehicle 30 (electric vehicle or engine vehicle) along the specified travel route, and the CPU 11 can calculate, based on the map information, required travel energy E^{tend}_{drv_prd_cor}(te) as the corrected required travel energy E^{ti}_{drv_prd_cor}(te). An example of the map information is illustrated in FIG. 10.

In step S005, the CPU 11 serves as, for example, the third generator 103 to calculate total necessary energy, which will have been totally required by the target vehicle (electric vehicle) 30 from the prediction-request time ti to the end time te when the target vehicle 30 will travel along the scheduled travel route, using the corrected required travel energy E^{ti}_{drv_prd_cor}(te) and the travel-unrelated energy E^{ti}_{other_prd_cor}(te) in accordance with the following formula [f08]:

E^{ti}_{total_prd_cons_cor}(te)=E^{ti}_{drv_prd_cor}(te)+E^{ti}_{other_prd_base}(te) [f08]
where E^{ti}_{total_prd_cons_cor}(te) represents the total necessary energy that will have been totally required by the target vehicle (electric vehicle) 30 from the prediction-request time ti to the end time te when the target vehicle 30 will travel along the scheduled travel route.

Alternatively, following the calculation of the traveling horsepower P_{drv}(t), the CPU 11 calculates, based on the traveling horsepower Pdrv(t), input energy PI_{drv}(t) inputted to the vehicle drive system 31 in a case where the target vehicle 30 is an engine vehicle in step S002A.

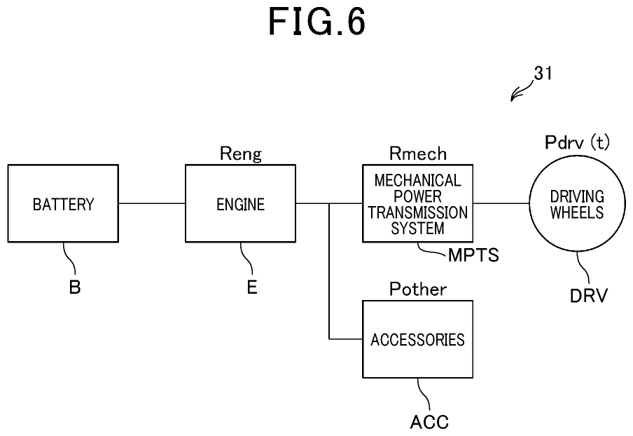

FIG. 6 is a block diagram schematically illustrating an example of the vehicle drive system 31 employed by the target vehicle (engine vehicle) 30.

Specifically, the vehicle drive system 31 includes an internal combustion engine (engine) E, the mechanical power transmission system MPTS, the driving wheels DRV, and the accessories (ACC) including the air-conditioner. Specifically, the engine E creates drive power based on fuel to accordingly transmit the drive power, i.e., torque, to the driving wheels DRV through the mechanical power transmission system MPTS, making it possible to rotate the driving wheels DRV.

The engine E has a predetermined efficiency R_{eng}, and the mechanical power transmission system MPTS has the predetermined efficiency R_{mech}. The efficiency of the mechanical power transmission system MPTS is set to a fixed value of, for example, 70%.

Specifically, the efficiency R_{mech} of the mechanical power transmission system MPTS shows that input energy inputted to the mechanical power transmission system MPTS is transferred to the driving wheels DRV with the efficiency R_{mech} (%), so that the traveling horsepower P_{drv}(t) is generated.

Accordingly, the CPU 11 calculates, based on the traveling horsepower P_{drv}(t), the input energy PI_{drv}(t) inputted to the mechanical power transmission system MPTS of the vehicle drive system 31 in accordance with the following formula [f09] in step S002A:

PI_{drv}(t)=P_{drv}(t)/R_{mech} [f09]

In addition to energy, i.e., the drive power, to the driving wheels DRV, the engine E supplies energy required for driving the accessories ACC including the air-conditioner.

As described above, the accessory-drive energy Pₒₜₕₑᵣ(t) required to drive the accessories ACC can be set to a fixed value of, for example, 5 kW.

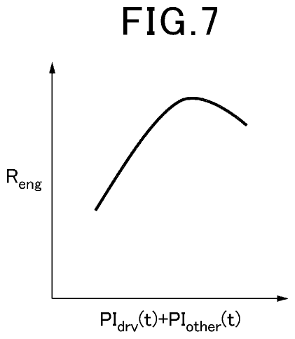

The efficiency R_{eng} of the engine E has a predetermined relationship with respect to the input energy PI_{drv}(t) supplied from the engine E to the mechanical power transmission system MPTS and the accessory-drive energy Pₒₜₕₑᵣ(t) required to drive the accessories ACC as illustrated in, for example, FIG. 7.

That is, the efficiency R_{eng} of the engine E is defined as a function g of the sum of (i) the input energy PI_{drv}(t) from the engine E to the mechanical power transmission system MPTS and (ii) the accessory-drive energy Pₒₜₕₑᵣ(t) required to drive the accessories ACC, and therefore the efficiency R_{eng} of the engine E can be expressed by the following formula [f10]:

R_{eng}=g(PI_{drv}(t)+Pₒₜₕₑᵣ(t)) [f10]

Following the calculation of the input energy PI_{drv}(t) in step S002A, the CPU 11 calculates, as engine energy Pₛᵤₘ(t), the sum of the input energy PI_{drv}(t) and the accessory-drive energy Pₒₜₕₑᵣ(t) in accordance with the following formula [f011] in step S003A:

Pₛᵤₘ(t)=PI_{drv}(t)+Pₒₜₕₑᵣ(t) [f11]

Accordingly, let us assume that input energy inputted to the engine E is expressed by reference character PAₛᵤₘ. In this assumption, the CPU 11 calculates the input energy PAₛᵤₘ in accordance with the following formula [f12]:

PAₛᵤₘ(t)=Pₛᵤₘ(t)/R_{eng} [f12]

Because the engine vehicle does not carry out charging of regenerative energy, the CPU 11 can determine positive values of the input energy PAₛᵤₘ as input energy PBₛᵤₘ to the engine E in accordance with the following formula [f13] in step S003A:

PBₛᵤₘ(t)=PAₛᵤₘ(t)(PAₛᵤₘ(t)>0) [f13]

Next, the CPU 11 integrates the input energy PBₛᵤₘ from the prediction-request time ti to the end time te in accordance with the following formula [f14] to accordingly calculate the total necessary energy E^{ti}_{total_prd_base}(te), which will have been required for the traveling of the target vehicle (engine vehicle) 30 from the prediction-request time ti to the end time te in step S003A:

E^{ti}_{total_prd_base}(te)=Σ(PB_{drv}(t)*(t−(t−1))) [f14]

Specifically, the total necessary energy E^{ti}_{total_prd_base}(te) for the target vehicle (engine vehicle) 30 is comprised of required travel energy E^{ti}_{drv_prd_base}(te) and the independent energy E^{ti}_{other_prd_base}(te), so that the CPU 11 calculates the traveling energy E^{ti}_{drv_prd_base}(te) and the travel-unrelated energy E^{ti}_{other_prd_base}(te) in accordance with the following formulas [f15] and [f16] in step S003A:

E^{ti}_{drv_prd_base}(te)=E^{ti}_{total_prd_base}(te)*(PI_{drv}(t)/PAₛᵤₘ(t)) [f15]

E^{ti}_{other_prd_base}(te)=E^{ti}_{total_prd_base}(te)−E^{ti}_{drv_prd_base}(te) [f16]

Next, the CPU 11 serves as, for example, the information retrieving unit 105 to retrieve, from the travel environment information storage 203, the correction coefficient K_{drv} based on the amount of snow on each sampled point of the specified travel route as the first variation factor in step S004A.

Then, the CPU 11 serves as, for example, the third generator 103 to correct the required travel energy E_{drv_prd_base}(te) by the correction coefficient K_{drv} to accordingly calculate the corrected required travel energy E^{ti}_{drv_prd_cor}(te) in accordance with the following formula [f17A] in step S005A:

E^{ti}_{drv_prd_cor}(te)=K_{drv}*E^{ti}_{drv_prd_base}(te) [f17A]

Additionally, the CPU 11 serves as, for example, the third generator 103 to correct the total necessary energy E^{ti}_{total_prd_base}(te) by the correction coefficient K_{drv} to accordingly calculate the corrected total necessary energy E^{ti}_{total_cons_prd_cor}(te) in accordance with the following formula [f17B] in step S005A:

E^{ti}_{total_cons_prd_cor}(te)=K_{drv}*E^{ti}_{total_prd_base}(te) [f1713]

To sum up, the CPU 11 makes it possible to calculate
(I) The corrected total necessary energy E^{ti}_{total_prd_cor}(te), which will have been totally required by the target vehicle 30 from the prediction-request time ti to the end time te when the target vehicle 30 will travel along the scheduled travel route
(II) The corrected required travel energy E^{ti}_{drv_prd_cor}(te), which will have been required for traveling of the target vehicle 30 along the scheduled travel route from the prediction-request time ti to the end time te

Following the operation in step S005, the CPU 11 serves as, for example, the third generator 103 to calculate consumed total energy, which has been totally consumed by the target vehicle (electric vehicle) from the start time t0 to the prediction-request time ti in accordance with the following formula [f18] in the same manner as generation of the total energy E^{ti}_{total_prd_cor}(te) in step S006:

E_{total_cons_cor}(ti)=E_{drv_cons_est}(ti)+E_{other_cons_base}(ti) [f18A]
where:
E_{total_cons_cor}(ti) represents the consumed total energy by the target vehicle (electric vehicle) 30 from the start time t0 to the prediction-request time ti;
E_{drv_cons_est}(ti) represents consumed travel energy, which has been consumed by the traveling of the target vehicle (electric vehicle) 30 along a past traveled route from the start time t0 to the prediction-request time ti; and
E_{other_cons_base}(ti) represents consumed travel-unrelated energy, which has been consumed from the start time t0 to the prediction-request time ti independently from the traveling of the target vehicle 30. The consumed travel-unrelated energy E_{other_cons_base}(ti) can be calculated in accordance with the formula [f07].

That is, the specified travel route is comprised of the past traveled route (from the start time t0 to the prediction-request time ti), and the scheduled travel route (from the prediction-request time ti to the end time te).

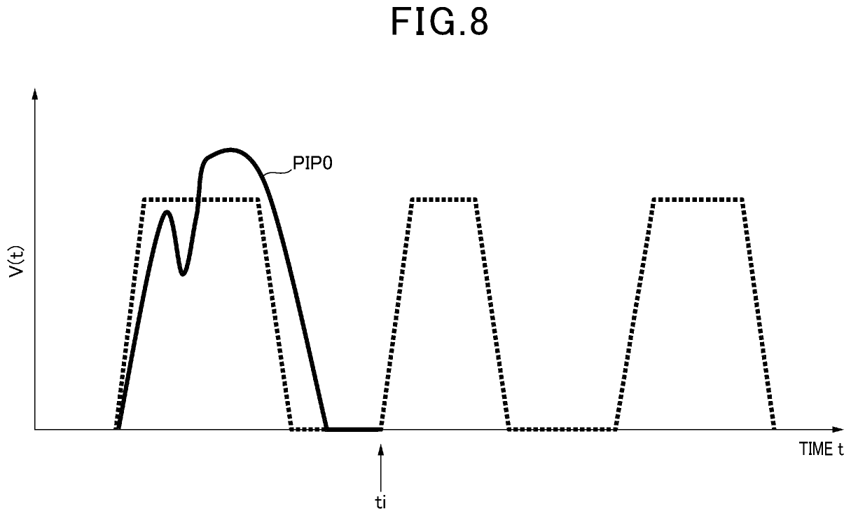

Note that the consumed travel energy E_{drv_cons_est}(ti) can be calculated by, for example, the second generator 102 in accordance with (i) a past actual vehicle-speed fluctuation pattern (see reference character PIP0 in FIG. 8) or the predicted past vehicle-speed fluctuation pattern PI0, (ii) the travel-route information stored in the travel-route information storage 202, and (iii) the values of the predetermined vehicle characteristic parameters stored in the vehicle characteristic information storage 201.

The consumed travel energy E_{drv_cons_est}(ti) can be corrected as EA_{drv_cons_est}(ti) expressed by the following formula [f18B]:

EA_{drv_cons_est}(ti)=K_{drv}*E_{drv_cons_est}(ti) [f18B]

Alternatively, following the operation in step S005A, the CPU 11 serves as, for example, the third generator 103 to calculate consumed total energy, which has been totally consumed by the target vehicle (engine vehicle) 30 from the start time t0 to the prediction-request time ti in accordance with the following formula [f19] in the same manner as generation of the corrected total energy E^{ti}_{total_prd_cor}(te) in step S006A:

E_{total_prd_cor}(ti)=K_{drv}*E_{total_prd_base}(ti) [f19]

The corrected consumed travel energy EA_{drv_cons_est}(ti) can be expressed by the above formula [f18B].

After the operation in step S006 or S006A, the CPU 11 terminates the energy prediction routine.

As described in detail above, the energy prediction apparatus 10 according to the first embodiment is configured to predict, as the total necessary energy that will have been totally required by the target vehicle from the prediction-request time t₁ to the end time te when the target vehicle 30 will travel along the scheduled travel route, the combination of
(I) The required travel energy that will have been required for the traveling of the target vehicle 30 (electric vehicle or engine vehicle) from the prediction-request time t₁ to the end time te
(II) The travel-unrelated energy required, when the target vehicle travels along the scheduled travel route from the prediction-request time ti to the end time te, by the target vehicle 30 independently from the traveling of the target vehicle 30

This configuration therefore makes it possible to offer how to predict the total necessary energy that will have been totally required by the target vehicle 30 when the target vehicle 30 will travel along the scheduled travel route with facility and high accuracy.

Additionally, this configuration of the energy prediction apparatus enables correction of the required travel energy in accordance with the first variation factor that has an influence on energy consumed by the traveling itself of the target vehicle 30 along the specified travel route, the required travel energy, making it possible to increase the accuracy of the correction of the required travel energy.

### Second Embodiment

The following describes the second embodiment of the present disclosure.

The configuration of the energy prediction apparatus of the second embodiment is substantially identical to that of the energy prediction apparatus of the first embodiment except that an energy prediction routine of the second embodiment is different from the energy prediction routine of the first embodiment. Accordingly, the following describes mainly the different points of the energy prediction apparatus of the second embodiment as compared with the energy prediction apparatus of the first embodiment.

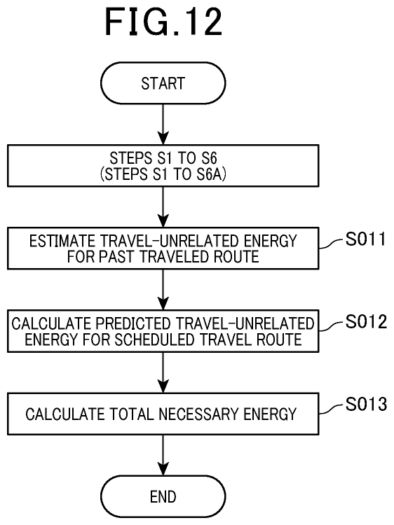

The following describes the energy prediction routine of the second embodiment based on the program instructions of the one or more programs stored in the memory unit 12 according to the second embodiment using the flowchart of FIG. 12; the energy prediction routine is carried out by the CPU 11 of the energy prediction apparatus 10 of the second embodiment. Description of operations in the energy prediction routine illustrated in FIG. 12, which are respectively identical to operations in the energy prediction routine illustrated in FIG. 2, is omitted while identical step numbers are assigned to respective identical operations between the energy prediction routines illustrated in respective FIGS. 2 and 12.

Following the operation in step S006 or S006A, the CPU 11 serves as, for example, the fourth generator 104 to estimate travel-unrelated energy E_{other_cons_esta}(ti) which has been consumed from the start time t0 to the prediction-request time ti independently from the traveling of the target vehicle 30 in step S011.

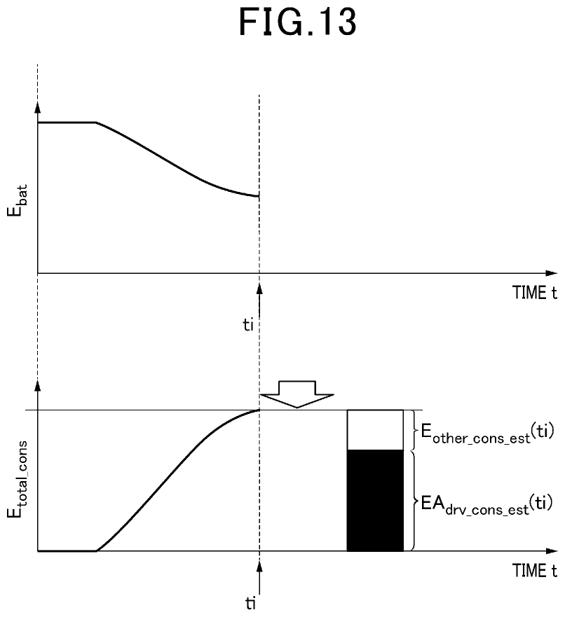

Specifically, in step S011, the CPU 11 serves as, for example, the fourth generator 104 to integrate, as illustrated in FIG. 13, an SOC deviation defined by subtraction of a current value E_{bat}(tn) of the SOC of the battery B from an immediately previous value E_{bat}(tn−1) of the SOC of the battery B, which is expressed by (E_{bat}(tn−1)−E_{bat}(tn)), from the start time t0 to time t=ti in accordance with the following formula [f20] to accordingly calculate consumed total energy that has been totally consumed by the target vehicle 30 during traveling of the target vehicle along the past traveled route from the start time t0 to the prediction-request time ti, which will be referred to as E_{total_cons}(ti):

E_{total_cons}(ti)=Σ(E_{bat}(tn−1)−E_{bat}(tn))+E_{total_cons}(ti−1) [f20]

Next, in step S011, the CPU 11 serves as, for example, the fourth generator 104 to subtract the corrected consumed travel energy EA_{drv_cons_est}(ti) represented by the above formula [f18B] from the calculated consumed total energy E_{total_cons}(ti) to accordingly calculate estimated consumed travel-unrelated energy E^{t0}_{other_cons_est}(ti), which has been consumed during traveling of the target vehicle 30 along the past traveled route from the start time t0 to the prediction-request time ti independently from the traveling of the target vehicle 30 in accordance with the following formula [f21]:

E_{other_cons_est}(ti)=E_{total_cons}(ti)−EA_{drv_cons_est}(ti) [f21]

Following the operation in step S011, the CPU 11 serves as, for example, the fourth generator 104 to calculate time average of the estimated consumed travel-unrelated energy E_{other_cons_est}(ti) based on time (ti−t0) to accordingly calculate power (work rate) P_{other_cons_est}(ti) in accordance with the following formula [f22] assuming that the consumption of the travel-unrelated energy is proportional to time in step S012:

P_{other_cons_est}(ti)=E_{other_cons_est}(ti)/(ti−t0) [f22]

Then, in step S012, the CPU 11 serves as, for example, the fourth generator 104 to calculate, based on the formula [f22] and the time (te−ti), predicted travel-unrelated energy E^{ti}_{other_cons_prd_cor}(te) that will have been consumed from prediction-request time t₁ to the end time te independently from the traveling of the target vehicle 30 in accordance with the following formula [f23]:

E^{ti}_{other_cons_prd_cor}(te)=P_{other_cons_est}(ti)*(te−ti) [f23]

Following the operation in step S012, the CPU 11 serves as, for example, the third generator 103 to calculate, based on the formula [f08] or [f17A] and the formula [f23], the corrected total necessary energy E^{ti}_{total_cons_prd_cor}(te) in accordance with the following formula in step S013:

E^{ti}_{tota_cons_prd_cor}(te)=E^{ti}_{drv_prd_cor}(te)+E^{ti}_{other_cons_prd_cor}(te) [f24]

### Third Embodiment

The following describes the third embodiment of the present disclosure.

The configuration of the energy prediction apparatus of the third embodiment is substantially identical to that of the energy prediction apparatus of the first or second embodiment except that an energy prediction routine of the third embodiment is different from the energy prediction routine of the first or second embodiment. Accordingly, the following describes mainly the different points of the energy prediction apparatus of the third embodiment as compared with the energy prediction apparatus of the first or second embodiment.

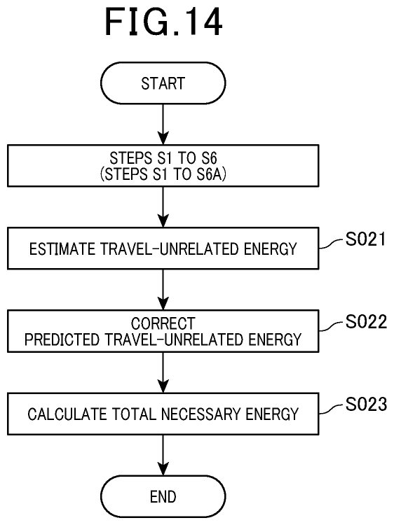

The following describes the energy prediction routine of the third embodiment based on the program instructions of the one or more programs stored in the memory unit 12 according to the third embodiment using the flowchart of FIG. 14; the energy prediction routine is carried out by the CPU 11 of the energy prediction apparatus 10 of the third embodiment. Description of operations in the energy prediction routine illustrated in FIG. 14, which are respectively identical to operations in the energy prediction routine illustrated in FIG. 2, is omitted while identical step numbers are assigned to respective identical operations between the energy prediction routines illustrated in respective FIGS. 2 and 14.

Following the operation in step S006 or S006A, the CPU 11 serves as, for example, the fourth generator 104 to estimate, like the first embodiment, the travel-unrelated energy E^{ti}_{other_prd_base}(te) that will have been consumed from prediction-request time ti to the end time te independently from the traveling of the target vehicle 30 in accordance with the above formula [f07] or the above formula [f16] in step S021:

E^{ti}_{other_prd_base}(te)=E(Pₒₜₕₑᵣ(t)*(t−(t−1))) [f07]

E^{ti}_{other_prd_base}(te)=E^{ti}_{total_prd_base}(te)−E^{ti}_{drv_prd_base}(te) [f16]

Following the operation in step S021, the CPU 11 serves as, for example, the information retrieving unit 105 to retrieve, from the travel environment information storage 203, the environmental variation-factor information stored in the travel environment information storage 203 in step S022.

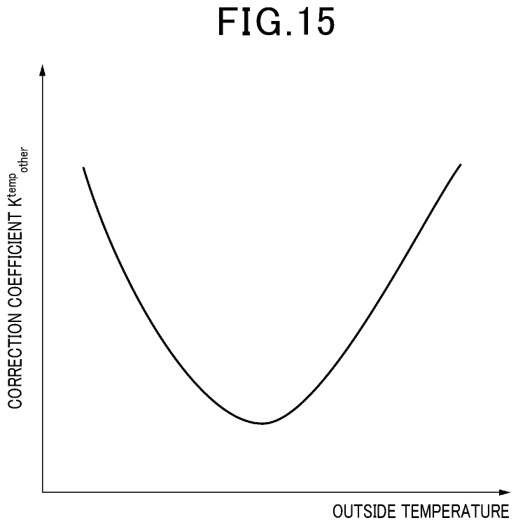

For example, the CPU 11 retrieves, from the travel environment information storage 203, the correction coefficient, which will be referred to as K^{termp}ₒₜₕₑᵣ based on the outside temperature around each sampled point of the specified travel route as the second variation factor in step S022. FIG. 15 shows an example of the correction coefficient K^{temp}ₒₜₕₑᵣ as a function of the outside temperature around the specified travel route.

In step S022, the CPU 11 serves as, for example, the third generator 103 to predict travel-unrelated energy E^{ti}_{other_cons_prd}(te) that will have been consumed from prediction-request time ti to the end time te independently from the traveling of the target vehicle 30 as a function of the estimated consumed travel-unrelated energy E_{other_cons_est}(ti) calculated in accordance with the above formula [f21].

Then, in step S022, the CPU 11 serves as, for example, the third generator 103 to correct the predicted travel-unrelated energy E^{ti}_{other_cons_prd}(te) using the correction coefficient K^{temp}ₒₜₕₑᵣ in accordance with the following formula [f25] to accordingly calculate corrected travel-unrelated energy E^{ti}_{other_cons_prd_cor}(te):

E^{ti}_{other_cons_prd_cor}(te)=K^{temp}ₒₜₕₑᵣ*E^{ti}_{other_cons_prd}(te) [f25]

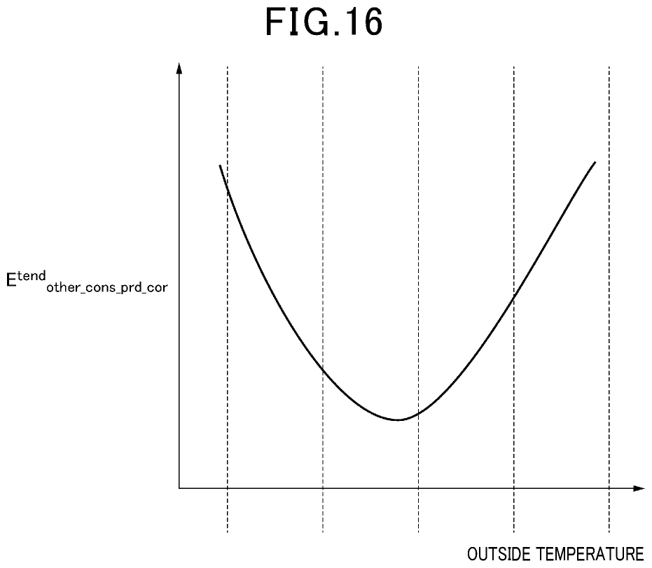

The energy prediction apparatus 10 or the travel environment information storage 203 can store map information indicative of a relationship between the second variation factor, i.e., the outside temperature around the specified travel route and travel-unrelated energy E^{tend}_{other_cons_prd_cor}(te) as the corrected travel-unrelated energy E^{ti}_{other_cons_prd_cor}(te), and the CPU 11 can calculate, based on the map information, the corrected travel-unrelated energy E^{ti}_{other_cons_prd_cor}(te). An example of the map information is illustrated in FIG. 16.

Following the operation in step S022, the CPU 11 serves as, for example, the third generator 103 to correct the required travel energy E_{drv_prd_base}(te) by the correction coefficient K_{drv} to accordingly calculate, based on the formula [f08] or [f17A] and the formula [f25], the corrected total necessary energy E^{ti}_{total_cons_prd_cor}(te) in accordance with the following formula in step S023:

E^{ti}_{total_cons_prd_cor}(te)=E^{ti}_{drv_prd_cor}(te)+E^{ti}_{other_cons_prd_cor}(te) [f24]

### Fourth Embodiment

The following describes the fourth embodiment of the present disclosure.

The configuration of the energy prediction apparatus of the fourth embodiment is substantially identical to that of the energy prediction apparatus of the first, second, or third embodiment except that an energy prediction routine of the third embodiment is different from the energy prediction routine of the first, second, or third embodiment. Accordingly, the following describes mainly the different points of the energy prediction apparatus of the fourth embodiment as compared with the energy prediction apparatus of the first, second, or third embodiment.

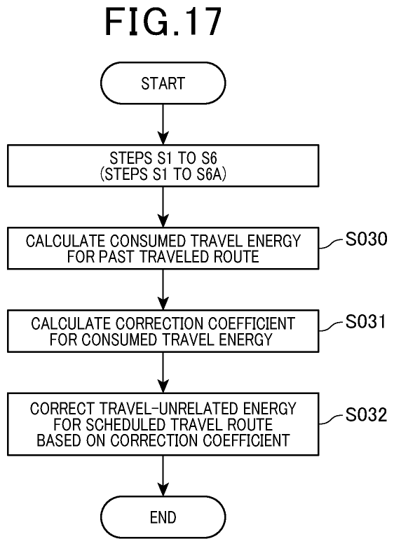

The following describes the energy prediction routine of the fourth embodiment based on the program instructions of the one or more programs stored in the memory unit 12 according to the third embodiment using the flowchart of FIG. 17; the energy prediction routine is carried out by the CPU 11 of the energy prediction apparatus 10 of the fourth embodiment. Description of operations in the energy prediction routine illustrated in FIG. 17, which are respectively identical to operations in the energy prediction routine illustrated in FIG. 2, is omitted while identical step numbers are assigned to respective identical operations between the energy prediction routines illustrated in respective FIGS. 2 and 17.

Following the operation in step S006 or S006A, the CPU 11 serves as, for example, the fourth generator 104 to calculate the consumed travel-unrelated energy, which has been consumed from the start time t0 to the prediction-request time ti independently from the traveling of the target vehicle 30 in accordance with the above formula [f07] or the above formula [f16] in step S030:

Σ_{other_prd_base}(ti)=Σ(Pₒₜₕₑᵣ(t)*(t−(t−1))) [f07]

E_{other_prd_base}(ti)=E_{total_prd_base}(ti)−E_{drv_prd_base}(ti) [f16]

Following the operation in step S030, the CPU 11 serves as, for example, the third generator 103 to calculate, as a correction coefficient K^{other}(ti), the ratio of the estimated consumed travel-unrelated energy E_{other_cons_est}(ti) calculated in accordance with the above formula [f21] to the consumed travel-unrelated energy E_{other_cons_base}(ti) calculated in accordance with the formula [f07] in accordance with the following formula [f26] in step S031:

Kₒₜₕₑᵣ(ti)=E_{other_cons_est}(ti)/E_{other_prd_base}(ti) [f26]

Following the operation in step S031, the CPU 11 serves as, for example, the third generator 103 to correct the travel-unrelated energy E^{ti}_{other_cons_prd}(te) using the correction coefficient K^{other}(ti) in accordance with the following formula [f27] in step S032:

E^{ti}_{other_cons_prd_cor}(te)=K^{other}(ti)*E^{ti}_{other_cons_prd}(te) [f27]
where E^{ti}_{other_cons_prd_cor}(te) represents corrected travel-unrelated energy

Then, in step S032, the CPU 11 serves as, for example, the third generator 103 to calculate, based on the formula [f08] or [f17A] and the formula [f27], the corrected total necessary energy E^{ti}_{total_cons_prd_cor}(te) in accordance with the following formula [24]:

E^{ti}_{tota_cons_prd_cor}(te)=E^{ti}_{drv_prd_cor}(te)+E^{ti}_{other_cons_prd_cor}(te) [f24]

Calculation of the correction coefficient K_{drv} as the first variation factor cannot be limited to the above calculation.

Specifically, the correction coefficient K_{drv} as the first variation factor can be calculated based on the probability of the amount of snow on each sampled point of the specified travel route.

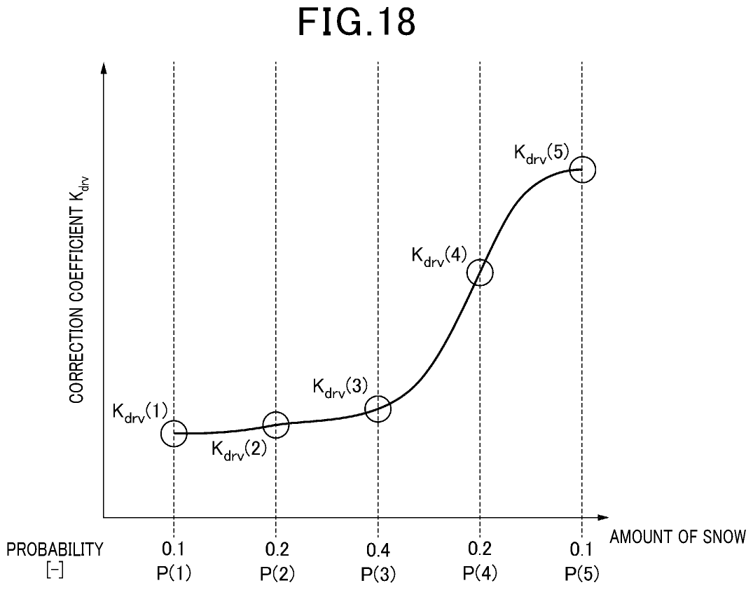

Specifically, FIG. 18 shows an example of map information indicative of a relationship between values P(1)=0.1, P(2)=0.2, . . . of the probability P of the amount of snow on the respective sampled points of the specified travel route and corresponding values K_{drv}(1), K_{drv}(2), . . . of the correction coefficient K_{drv}, and the CPU 11 can calculate, based on the map information, the sum of the product of the probability P and the correction coefficient K_{drv} from the prediction-request time ti to the end time to in accordance with the following formula [f28]:

K_{drv}=ΣP(e)*K_{drv}(e) [f28]

Then, the CPU 11 can serve as, for example, the third generator 103 to correct, like the operation in step S004 or S005A, the required travel energy E^{ti}_{drv_prd_base}(te) using the correction coefficient K_{drv} in accordance with the formula [f07A] or [f17A]:

E^{ti}_{drv_prd_cor}(te)=K_{drv}*E^{ti}__{prd_base}(te) [f07A]

E^{ti}_{drv_prd_cor}(te)=K_{drv}*E^{ti}_{drv_prd_base}(te) [f17A]

Similarly, calculation of the correction coefficient K_{drv} as the first variation factor cannot be limited to the above calculation.

Specifically, the correction coefficient K^{temp}ₒₜₕₑᵣ as the second variation factor can be calculated based on the probability of the outside temperature around each sampled point of the specified travel route.

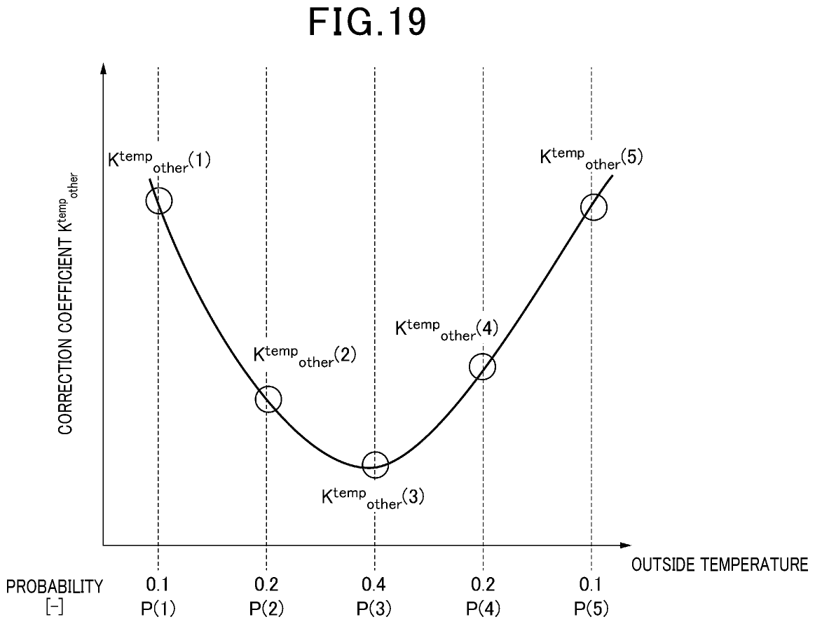

Specifically, FIG. 19 shows an example of map information indicative of a relationship between values PA(1)=0.1, PA(2)=0.2, . . . of the probability PA of the outside temperature around the respective sampled points of the specified travel route and corresponding values K^{tenp}ₒₜₕₑᵣ(1), K^{temp}ₒₜₕₑᵣ(2), . . . of the correction coefficient K^{temp}ₒₜₕₑᵣ, and the CPU 11 can calculate, based on the map information, the sum of the product of the probability PA and the correction coefficient K^{temp}ₒₜₕₑᵣ from the prediction-request time ti to the end time te in accordance with the following formula [f29]:

K^{tenp}ₒₜₕₑᵣ=ΣPA(e)*Kₒₜₕₑᵣ^{temp}(e) [f29]

Then, the CPU 11 can serve as, for example, the third generator 103 to calculate, like the operation in step S022, corrected travel-unrelated energy E^{ti}_{other_cons_prd_cor}(te):

E^{ti}_{other_cons_prd_cor}(te)=K^{temp}ₒₜₕₑᵣ*E^{ti}_{other_cons_prd}(te) [f25]

Calculation of the corrected required travel energy E^{ti}_{drv_prd_cor}(te) can be calculated based on the probability of the amount of snow on each sampled point of the specified travel route.

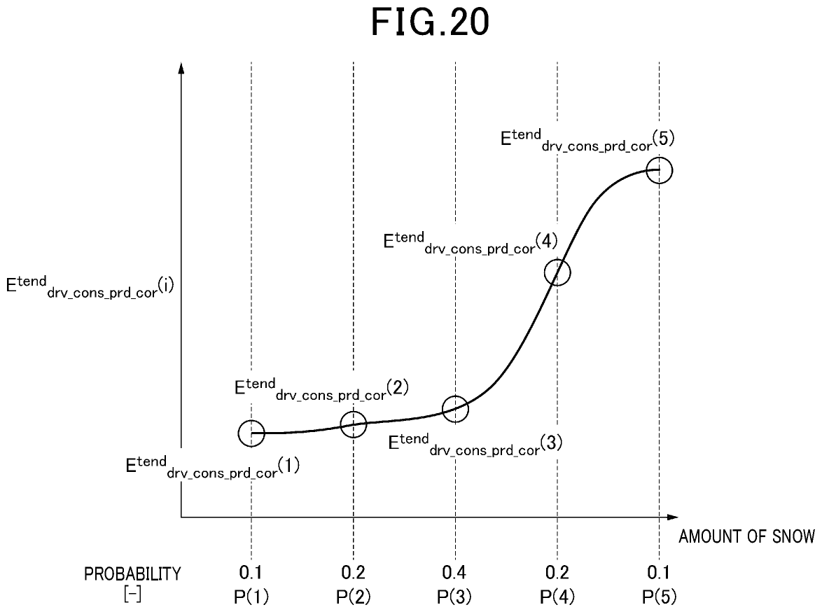

Specifically, FIG. 20 shows an example of map information indicative of a relationship between values PB(1)=0.1, PB(2)=0.2, . . . of the probability PB of the amount of snow on the respective sampled points of the specified travel route and corresponding values E^{tend}_{drv_prd_cor}(1), E^{tend}_{drv_prd_cor}(2), . . . of corrected required travel energy E^{trend}_{drv_prd_cor}(k) as the corrected required travel energy E^{ti}_{drv_prd_cor}(te), and the CPU 11 can calculate, based on the map information, the sum of the product of the probability PB and the corrected required travel energy E^{trend}_{drv_prd_cor}(te) from the prediction-request time ti to the end time te in accordance with the following formula [f30]:

E^{trend}_{drv_prd_cor}(te)=ΣPB(e)*E_{drv_prd_cor}^{tend}(e) [f30]

Calculation of the travel-unrelated energy E^{ti}_{other_prd_cor}(te) can be calculated based on the probability of the outside temperature around each sampled point of the specified travel route.

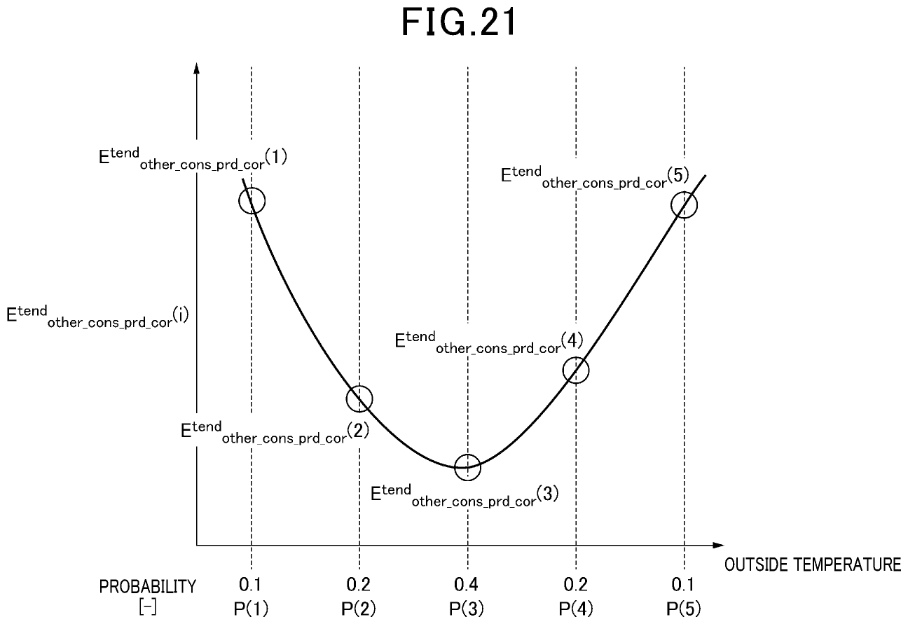

Specifically, FIG. 21 shows an example of map information indicative of a relationship between values PC(1)=0.1, PC(2)=0.2, . . . of the probability PC of the outside temperature around the respective sampled points of the specified travel route and corresponding values E^{tend}_{other_prd_cor}(1), E^{tend}_{other_prd_cor}(2), . . . of travel-unrelated energy E^{tend}_{other_prd_cor}(k) as the travel-unrelated energy E^{ti}_{other_prd_cor}(te), and the CPU 11 can calculate, based on the map information, the sum of the product of the probability PC and the travel-unrelated energy E^{tend}_{other_prd_cor}(k) from the prediction-request time ti to the end time to in accordance with the following formula [f31]:

E^{tend}_{other_prd_cor}(te)=ΣPC(e)*E_{other_prd_cor}^{tend}(e) [f31]

The following describes first to eighth exemplary measures that can be freely combined with one another as long as there is no technical contradiction in each combination.

The first exemplary measure provides an energy prediction apparatus.

The energy prediction apparatus of the first exemplary measure includes a first generator 101 configured to predict a vehicle-speed fluctuation condition indicative of how a speed of a target vehicle fluctuates over time while the target vehicle will travel along a scheduled travel route to accordingly generate the vehicle-speed fluctuation condition as first predicted information. The energy prediction apparatus of the first exemplary measure includes a second generator 102 configured to predict, based on the first predicted information, required travel energy required for the target vehicle to travel along the scheduled travel route to accordingly generate the required travel energy as second predicted information. The energy prediction apparatus of the first exemplary measure includes an information retrieving unit 105 configured to retrieve environmental variation-factor information on the scheduled travel route, the environmental variation-factor information having an influence on energy consumed by the target vehicle during traveling of the target vehicle along the scheduled travel route. The energy prediction apparatus of the first exemplary measure includes a third generator 103 configured to reflect the environmental variation-factor information on the second predicted information, and predict, based on the second predicted information on which the environmental variation-factor information has been reflected, total necessary energy required for the target vehicle to travel along the scheduled travel route to accordingly generate the total necessary energy as third predicted information.

The first exemplary measure reflects the environmental variation-factor information having an influence on energy consumed by the target vehicle during traveling of the target vehicle along the scheduled travel route on the second predicted information to accordingly predict, based on the second predicted information on which the environmental variation-factor information has been reflected, the total necessary energy required for the target vehicle to travel along the scheduled travel route.

This configuration of the first exemplary measure therefore makes it possible to offer information about how to predict the total necessary energy that will have been totally required by the target vehicle with facility.

The energy prediction apparatus of the second exemplary measure depending from the first exemplary measure further includes a fourth generator 104 configured to generate, as fourth predicted information, travel-unrelated energy required, when the target vehicle travels along the scheduled travel route, by the target vehicle independently from traveling of the target vehicle along the scheduled travel route.

The third generator 103 is configured to generate, based on (i) the second predicted information on which the environmental variation-factor information has been reflected, and (ii) the fourth predicted information, the third predicted information.

The second exemplary measure predicts the third predicted information based on (i) the second predicted information on which the environmental variation-factor information has been reflected, and (ii) the fourth predicted information.

This configuration therefore makes it possible to predict, with higher accuracy and facility, the total necessary energy that will have been totally required by the target vehicle.

The third generator 103 of the energy prediction apparatus of the third exemplary measure depending from the first or second exemplary measure is configured to multiply the required travel energy as the second predicted information by a first correction coefficient that represents an estimated first variation factor included in the environmental variation-factor information to accordingly reflect the environmental variation-factor information on the second predicted information.

This configuration reflects the environmental variation-factor information on the second predicted information using the first correction coefficient that represents the estimated first variation factor included in the environmental variation-factor information, making it possible to predict, with higher accuracy and facility, the total necessary energy that will have been totally required by the target vehicle.

The second generator 102 of the energy prediction apparatus of the fourth exemplary measure, which depends from the second or third exemplary measure is configured to calculate, based on a past vehicle-speed fluctuation condition and the environmental variation-factor information, consumed travel energy that has been consumed by traveling of the target vehicle along a past traveled route. The past traveled route represents a route along which the target vehicle has traveled before the scheduled route, and the past vehicle-speed fluctuation condition represents how the speed of the target vehicle has fluctuated over time during traveling of the target vehicle along the past traveled route.

The fourth generator 104 is configured to calculate consumed total energy that has been totally consumed by the target vehicle during traveling of the target vehicle along the past traveled route. The fourth generator 104 is configured to subtract the consumed travel energy from the consumed total energy to accordingly calculate consumed travel-unrelated energy that has been consumed during traveling of the target vehicle along the past traveled route independently from traveling of the target vehicle along past traveled route. The fourth generator 104 is configured to generate, based on the consumed travel-unrelated energy, the fourth predicted information.

This configuration of the fourth exemplary measure subtracts the consumed travel energy from the consumed total energy to accordingly calculate the consumed travel-unrelated energy that has been consumed during traveling of the target vehicle along the past traveled route independently from traveling of the target vehicle along past traveled route. This therefore makes it possible to predict, which higher accuracy and facility, the total necessary energy that will have been totally required by the target vehicle.

The fourth generator 104 of the energy prediction apparatus of the fifth exemplary measure, which depends from the fourth exemplary measure, is configured to calculate time average of the consumed travel-unrelated energy, and multiply the time average of the consumed travel-unrelated energy by time that is needed by traveling of the target vehicle along the scheduled travel route based on the vehicle-speed fluctuation condition to accordingly calculate the fourth predicted information.

This configuration of the fifth exemplary measure, which uses the fact that the consumed travel-unrelated energy is proportional to time, calculates the time average of the consumed travel-unrelated energy, and thereafter multiply the time average of the consumed travel-unrelated energy by time that is needed by traveling of the target vehicle along the scheduled travel route based on the vehicle-speed fluctuation condition to accordingly calculate the fourth predicted information.

This configuration therefore enables prediction of the total necessary energy that will have been totally required by the target vehicle to be simplified.

The information retrieving unit 105 of the energy prediction apparatus of the sixth exemplary measure, which depends from any one of the second to fifth exemplary measures, is configured to retrieve the environmental variation-factor information that has an influence on independent energy consumed, when the target vehicle travels along the scheduled travel route, in the target vehicle independently from the traveling of the target vehicle along the scheduled travel route.

The third generator is configured to reflect the environmental variation-factor information on the second predicted information, reflect the environmental variation-factor information on the fourth predicted information, and generate the third predicted information based on (i) the second predicted information on which the environmental variation-factor information has been reflected; and (ii) the fourth predicted information on which the environmental variation-factor information has been reflected.

The sixth exemplary measure, which generates the third predicted information based on (i) the second predicted information on which the environmental variation-factor information has been reflected; and (ii) the fourth predicted information on which the environmental variation-factor information has been reflected, makes it possible to predict, with higher accuracy and facility, the total necessary energy that will have been totally required by the target vehicle.

The third generator 103 of the energy prediction apparatus of the seventh exemplary measure, which depends from the sixth exemplary measure, is configured to multiply the required travel energy as the second predicted information by an estimated second correction coefficient included in the environmental variation-factor information to accordingly reflect the environmental variation-factor information on the second predicted information, and multiply the travel-unrelated energy as the fourth predicted information by the estimated second correction coefficient included in the environmental variation-factor information to accordingly reflect the environmental variation-factor information on the fourth predicted information.

This configuration of the seventh exemplary measure multiplies the required travel energy by the estimated second correction coefficient included in the environmental variation-factor information to reflect the environmental variation-factor information on the second predicted information, and multiplies the travel-unrelated energy by the estimated second correction coefficient to reflect the environmental variation-factor information on the fourth predicted information. This configuration therefore predicts, with higher accuracy and facility, the total necessary energy that will have been totally required by the target vehicle.

The fourth generator 104 of the energy prediction apparatus of the eighth measure, which depends from the second exemplary measure, is configured to generate, as fifth predicted information, predicted travel-unrelated energy that has been consumed during traveling of the target vehicle along a past traveled route. The past traveled route represents a route along which the target vehicle has traveled before the scheduled route.

The second generator 102 is configured to calculate, based on a past vehicle-speed fluctuation condition and the environmental variation-factor information, consumed travel energy that has been consumed by traveling of the target vehicle along the past traveled route. The past vehicle-speed fluctuation condition represents how the speed of the target vehicle has fluctuated over time during traveling of the target vehicle along the past traveled route.

The fourth generator 104 is configured to calculate consumed total energy that has been totally consumed by the target vehicle during traveling of the target vehicle along the past traveled route.

The fourth generator 104 is configured to subtract the consumed travel energy from the consumed total energy to accordingly calculate consumed travel-unrelated energy that has been consumed during traveling of the target vehicle along the past traveled route independently from traveling of the target vehicle along past traveled route.

The fourth generator 104 is configured to generate, based on the predicted travel-unrelated energy and the calculated consumed travel-unrelated energy, the fourth predicted information.

The eighth exemplary measure generates, based on both the predicted travel-unrelated energy and the calculated consumed travel-unrelated energy, the fourth predicted information, making it possible to predict, with higher accuracy and facility, the total necessary energy that will have been totally required by the target vehicle.

The energy prediction apparatuses and energy prediction methods described in the present disclosure can be implemented by a dedicated computer including a memory and a processor programmed to perform one or more functions embodied by one or more computer programs.

The energy prediction apparatuses and energy prediction methods described in the present disclosure can also be implemented by a dedicated computer including a processor comprised of one or more dedicated hardware logic circuits.

The energy prediction apparatuses and energy prediction methods described in the present disclosure can further be implemented by a processor system comprised of a memory, a processor programmed to perform one or more functions embodied by one or more computer programs, and one or more hardware logic circuits.

The one or more programs can be stored in a non-transitory storage medium as instructions to be carried out by a computer or a processor. One or more functions included in each of the energy consumption calculation apparatuses disclosed in the present disclosure can be implemented by one or more programmed logic circuits, one or more hardwired logic circuits, and/or one or more hardwired-logic and programmable-logic hybrid circuits.

While the illustrative embodiments of the present disclosure have been described herein, the present disclosure is not limited to the embodiments described herein, but includes any and all embodiments having modifications, omissions, combinations (e.g., of aspects across various embodiments), adaptations and/or alternations as would be appreciated by those having ordinary skill in the art based on the present disclosure. The limitations in the claims are to be interpreted broadly based on the language employed in the claims and not limited to examples described in the present specification or during the prosecution of the application, which examples are to be construed as non-exclusive.

1. An energy prediction apparatus comprising:
a first generator configured to predict a vehicle-speed fluctuation condition indicative of how a speed of a target vehicle fluctuates over time while the target vehicle will travel along a scheduled travel route to accordingly generate the vehicle-speed fluctuation condition as first predicted information;
a second generator configured to predict, based on the first predicted information, required travel energy required for the target vehicle to travel along the scheduled travel route to accordingly generate the required travel energy as second predicted information;
an information retrieving unit configured to retrieve environmental variation-factor information on the scheduled travel route, the environmental variation-factor information having an influence on energy consumed by the target vehicle during traveling of the target vehicle along the scheduled travel route; and
a third generator configured to:
reflect the environmental variation-factor information on the second predicted information; and
predict, based on the second predicted information on which the environmental variation-factor information has been reflected, total necessary energy required for the target vehicle to travel along the scheduled travel route to accordingly generate the total necessary energy as third predicted information.

2. The energy prediction apparatus according to claim 1, further comprising:
a fourth generator configured to generate, as fourth predicted information, travel-unrelated energy required, when the target vehicle travels along the scheduled travel route, by the target vehicle independently from traveling of the target vehicle along the scheduled travel route,
wherein:
the third generator is configured to generate, based on (i) the second predicted information on which the environmental variation-factor information has been reflected, and (ii) the fourth predicted information, the third predicted information.

3. The energy prediction apparatus according to claim 1, wherein:
the third generator is configured to multiply the required travel energy as the second predicted information by a first correction coefficient that represents an estimated first variation factor included in the environmental variation-factor information to accordingly reflect the environmental variation-factor information on the second predicted information.

4. The energy prediction apparatus according to claim 2, wherein:
the second generator is configured to:
calculate, based on a past vehicle-speed fluctuation condition and the environmental variation-factor information, consumed travel energy that has been consumed by traveling of the target vehicle along a past traveled route, the past traveled route representing a route along which the target vehicle has traveled before the scheduled route, the past vehicle-speed fluctuation condition representing how the speed of the target vehicle has fluctuated over time during traveling of the target vehicle along the past traveled route; and
the fourth generator is configured to:
calculate consumed total energy that has been totally consumed by the target vehicle during traveling of the target vehicle along the past traveled route;
subtract the consumed travel energy from the consumed total energy to accordingly calculate consumed travel-unrelated energy that has been consumed during traveling of the target vehicle along the past traveled route independently from traveling of the target vehicle along past traveled route; and
generate, based on the consumed travel-unrelated energy, the fourth predicted information.

5. The energy prediction apparatus according to claim 4, wherein:
the fourth generator is configured to:
calculate time average of the consumed travel-unrelated energy; and
multiply the time average of the consumed travel-unrelated energy by time that is needed by traveling of the target vehicle along the scheduled travel route based on the vehicle-speed fluctuation condition to accordingly calculate the fourth predicted information.

6. The energy prediction apparatus according to claim 2, wherein:
the information retrieving unit is configured to retrieve the environmental variation-factor information that has an influence on independent energy consumed, when the target vehicle travels along the scheduled travel route, in the target vehicle independently from the traveling of the target vehicle along the scheduled travel route; and
the third generator is configured to:
reflect the environmental variation-factor information on the second predicted information;
reflect the environmental variation-factor information on the fourth predicted information; and
generate the third predicted information based on (i) the second predicted information on which the environmental variation-factor information has been reflected; and (ii) the fourth predicted information on which the environmental variation-factor information has been reflected.

7. The energy prediction apparatus according to claim 6, wherein:
the third generator is configured to:
multiply the required travel energy as the second predicted information by an estimated second correction coefficient included in the environmental variation-factor information to accordingly reflect the environmental variation-factor information on the second predicted information; and
multiply the travel-unrelated energy as the fourth predicted information by the estimated second correction coefficient included in the environmental variation-factor information to accordingly reflect the environmental variation-factor information on the fourth predicted information.

8. The energy prediction apparatus according to claim 2, wherein:
the fourth generator is configured to generate, as fifth predicted information, predicted travel-unrelated energy that has been consumed during traveling of the target vehicle along a past traveled route, the past traveled route representing a route along which the target vehicle has traveled before the scheduled route;
the second generator is configured to calculate, based on a past vehicle-speed fluctuation condition and the environmental variation-factor information, consumed travel energy that has been consumed by traveling of the target vehicle along the past traveled route, the past vehicle-speed fluctuation condition representing how the speed of the target vehicle has fluctuated over time during traveling of the target vehicle along the past traveled route; and
the fourth generator is configured to
calculate consumed total energy that has been totally consumed by the target vehicle during traveling of the target vehicle along the past traveled route;
subtract the consumed travel energy from the consumed total energy to accordingly calculate consumed travel-unrelated energy that has been consumed during traveling of the target vehicle along the past traveled route independently from traveling of the target vehicle along past traveled route; and
generate, based on the predicted travel-unrelated energy and the calculated consumed travel-unrelated energy, the fourth predicted information.

9. A processor-readable non-transitory storage medium comprising:
a set of program instructions that cause at least one processor to:
predict a vehicle-speed fluctuation condition indicative of how a speed of a target vehicle fluctuates over time while the target vehicle will travel along a scheduled travel route to accordingly generate the vehicle-speed fluctuation condition as first predicted information;
predict, based on the first predicted information, required travel energy required for the target vehicle to travel along the scheduled travel route to accordingly generate the required travel energy as second predicted information;
retrieve environmental variation-factor information on the scheduled travel route, the environmental variation-factor information having an influence on energy consumed by the target vehicle during traveling of the target vehicle along the scheduled travel route;
reflect the environmental variation-factor information on the second predicted information; and
predict, based on the second predicted information on which the environmental variation-factor information has been reflected, total necessary energy required for the target vehicle to travel along the scheduled travel route to accordingly generate the total necessary energy as third predicted information.

10. A method, executable by a processor, comprising:
predicting a vehicle-speed fluctuation condition indicative of how a speed of a target vehicle fluctuates over time while the target vehicle will travel along a scheduled travel route to accordingly generate the vehicle-speed fluctuation condition as first predicted information;
predicting, based on the first predicted information, required travel energy required for the target vehicle to travel along the scheduled travel route to accordingly generate the required travel energy as second predicted information;
retrieving environmental variation-factor information on the scheduled travel route, the environmental variation-factor information having an influence on energy consumed by the target vehicle during traveling of the target vehicle along the scheduled travel route;
reflecting the environmental variation-factor information on the second predicted information; and
predicting, based on the second predicted information on which the environmental variation-factor information has been reflected, total necessary energy required for the target vehicle to travel along the scheduled travel route to accordingly generate the total necessary energy as third predicted information.
